(19) United States
(12) Patent Application Publication
(10) Pub. No.: US 2004/0020859 A1
(43) Pub. Date: Feb. 5, 2004

(54) Water treatment

(76) Inventor: Gavin Michael Walker, Northern Ireland (GB)

Correspondence Address: DRINKER BIDDLE & REATH, ONE LOGAN SQUARE, 18TH AND CHERRY STREETS, PHILADELPHIA, PA, 19103-6996, US

(21) Appl. No.: 10/363,563

(22) PCT Filed: Sep. 6, 2001
(86) PCT No.: PCT/GB01/03994

(30) Foreign Application Priority Data
Sep. 8, 2000 (GB) 00220491

(51) Int. Cl. C02F 1/42

(52) U.S. Cl. 210/681

(57) ABSTRACT

A process for obtaining an adsorbent/flocculent material comprises heating dolomite to around 800° C. The heated dolomite is washed with a suitable material able to increase its surface porosity, such as by removing any magnesium oxide from the surface pores. One particular washing substance is borax buffer. Use of the adsorbent/flocculent material of the invention to adsorb one or more substances such as nitrates and phosphates from a material such as water, is also described.

The present invention relates to water treatment by use of a dolomite adsorbent/flocculant.

Dolomite is the double carbonate of calcium and magnesium. It has a chemical formula of CaCO₃.MgCO₃. It is a well known substance, and to date has generally only been used in agriculture for neutralising soil acidity through a base exchange with calcium and magnesium cations displacing the hydrogen ions in the soil. This process has been reported to increase crop yield by 14-40%. Furthermore, dolomite is used to make up the magnesium loss in the soil due to plant growth and is extensively used to counteract the acidity of urea.

Thermal processing or “calcining” of dolomite is used to produce materials such as magnesium oxychloride cement, magnesium oxysulphate cement and inorganic magnesia foams. For these uses, the calcining process is based on the fact that the magnesium carbonate component of the dolomite decomposes at temperatures around 800° C. The partial calcining process proceeds according to following equation:

CaCO₃.MgCO₃→MgO+CO₂+CaCO₃

The decomposition of dolomite at 800° C. leads to changes in the chemical composition of the surface and the porosity of the mineral. Generally, the product of partial decomposition of dolomite contains calcium carbonate and magnesium oxide, and shows a significant increase in specific surface area and pore volume. These parameters further increase after the partially decomposed sample has been washed with borax buffer in order to remove magnesium oxide from the newly created pores. This is shown in the following Table 1.

| | Specific surface area |
|---|---|
| Sample | (m²g⁻¹) |
| Raw dolomite dried at 150 C. | 0.7 |
| Dolomite heated to 800 C. for 12 hours | 23 |
| Dolomite heated to 800 C. for 12 hours and | 36 |
| washed | |
| Dolomite heated to 800 C. for 24 hours | 25 |
| Dolomite heated to 800 C. for 24 hours and | 60 |
| washed | |

It is believed that the use of calcined dolomite has not been considered as an adsorbent/flocculant.

Thus, according to one aspect of the present invention, there is provided an adsorbent/flocculant material preparable by heating dolomite to around 800° C.

The dolomite can be heated (or “activated”) in any known heating or thermal process or calcination able to decompose the dolomite and change the surface porosity. It would be appreciated by those skilled in the art that the figure of “800° C.” is not limiting to achieve the desired adsorbent/flocculant material.

Current research suggests that the activated dolomite material acts in a combination of flocculation and adsorption processes. Hence, the material in termed herein “absorbent/flocculant material”.

The heating of the dolomite can be conducted under any suitable conditions. In some tests, the dolomite has been heated for 4 hours; in other tests 24 hours.

Preferably, the heated dolomite is washed with a suitable material able to increase its surface porosity, such as by removing any magnesium oxide from the surface pores. One particular washing substance is borax buffer.

According to a second aspect of the present invention, there is provided a process for providing an adsorbent/flocculant material wherein dolomite is heated to around 800° C.

According to a third aspect of the present invention, there is provided use of an adsorbent/flocculant material based on heated dolomite as hereinbefore defined, to adsorb one or more substances from a material to be treated, generally a liquid, more generally water.

Investigations into the adsorbence of a number of different materials have been conducted as hereinafter described. Thus it can be expected that the adsorbent/flocculant material of the present invention could be used in the treatment of most liquids.

According to a fourth aspect of the present invention there is provided an adsorbent/flocculant process for the treatment of a liquid material; generally water, wherein an adsorbent/flocculant material as hereinbefore defined is located in the path of a flow of the liquid material, and one or more substances in the liquid material are adsorbed by the adsorbent/flocculant material thereby. In particular, removal of target ions from aqueous solutions.

Embodiments of the present invention will now be described by way of example only.

Nitrate Adsorption

Nitrogen is a nutrient essential to life of all forms as it is a basic component of all proteins. However, too much unbalances the natural nitrogen cycle and has many side effects, from decreased soil fertility and eutrophication of water courses. Eutrophication has many causes, but mainly results from agricultural runoff from the nitrogen and ammonium nitrate present in fertilisers. It is also caused by the discharge of raw or untreated sewerage to water. In aquatic systems, the presence of nitrogen is vital. However, excess nitrogen enhances the growth of algae and other plants.

To test nitrate adsorption, raw Irish dolomite was used. A specific surface area of 11 m² was achieved after charring the dolomite for 24 hours at 800° C. The specific surface area after charring was 20 times greater than that of the raw dolomite. Equilibrium isotherm experiments were then undertaken using ammonium nitrate in aqueous solution. An equilibrium capacity of 72 mg (of nitrate) gram⁻¹ was attained.

Dye Adsorption/Flocculation

Dolomite was charred at about 800° C. and washed in borax buffer (di-Sodium Tetraborate) to provide an adsorbent/flocculant material having specific surface area, pore volume and average pore radius as set out in Table 1 hereinbefore. A set of isotherm experiments were conducted using Levafix Brilliant Red E-4BA and 0.5 grams of 4 hour charred dolomite and 0.5 grams of F400. The adsorption model was based on a state of equilibrium being reached when the rate of adsorption equalled the rate of desorption, giving a distribution of adsorbate between solid and liquid phases. When equilibrium is established, a graph can be provided showing the adsorbent/flocculant concentration in the solid phases (_{q}e) and the adsorbate concentration in the liquid phase, (Ce).

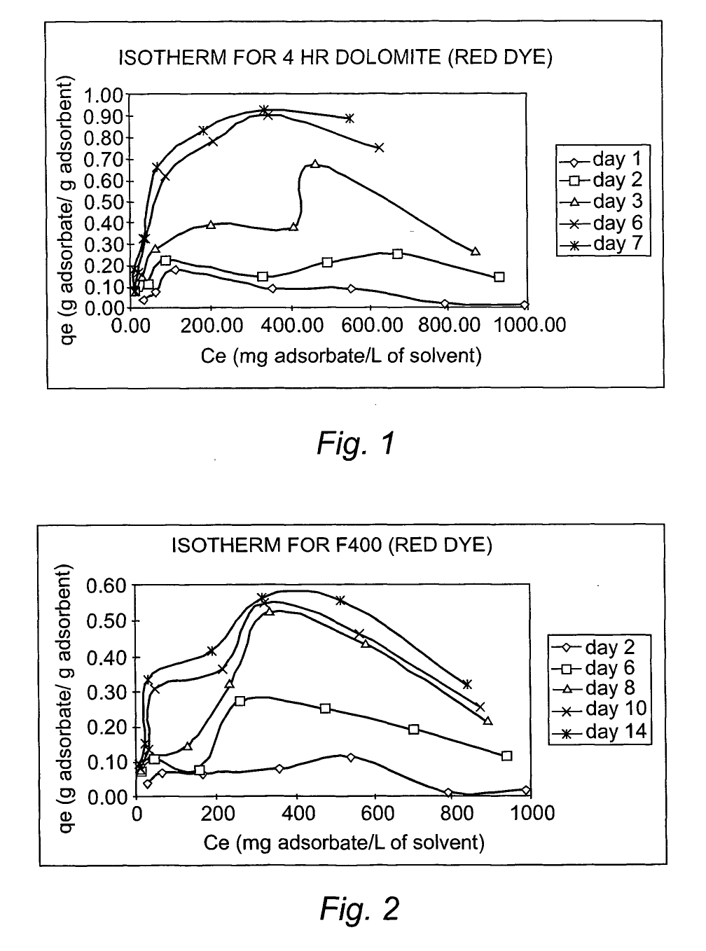

FIGS. 1 and 2 hereinafter show graphs for adsorption of the red dye by the calcined dolomite material of the present invention and F400. They show that the dolomite material is twice as effective as an adsorbent/flocculant as F400. Similar isotherm experiments were carried out using Levafix Brilliant. Blue E-B and 0.5 grams of F400 and 8 hour charred dolomite and 0.5 grams of F400. Using the same adsorption model as above,

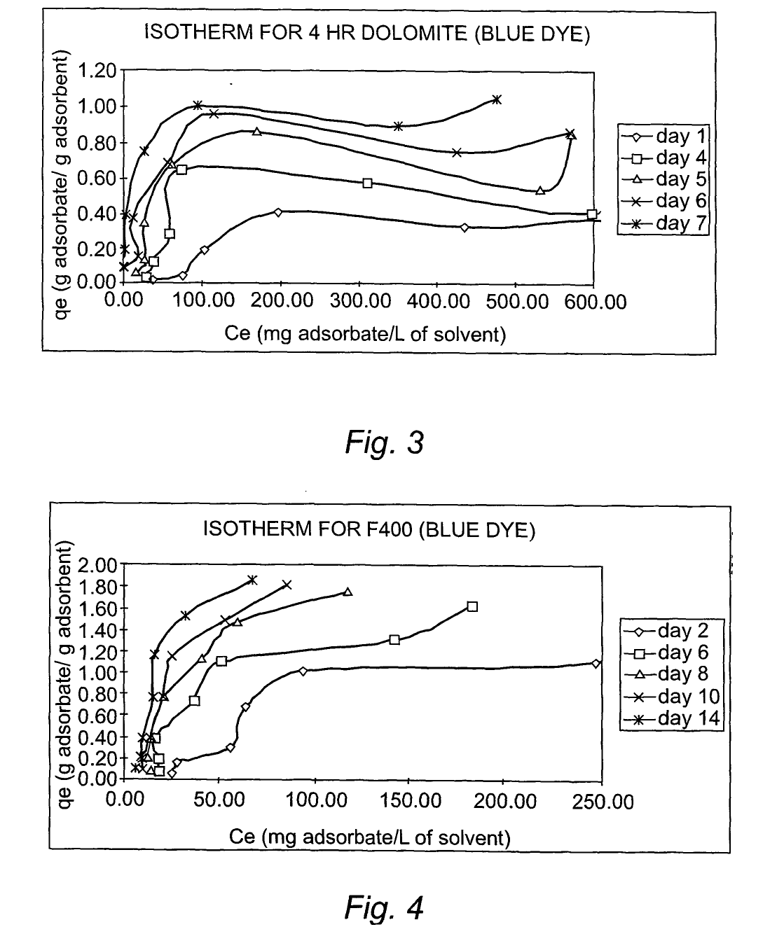

FIGS. 3 and 4 hereafter show results obtained from the dolomite material of the present invention and F400 based on the blue dye material. These showed similar effectiveness as with red dye adsorption.

### TRI-BUTYL TIN ADSORPTION/FLOCCULATION

Tri-butyl tin (TBT) is used as an anti-fouling agent in marine paint to prevent the growth of crustaceans on the hulls of ships. Ship repair marine companies are involved in the removal of paint and repainting of ship hulls. During these processes, large quantities of TBT are removed from the hull and pose a disposal problem. As TBT is harmful to the marine aquaculture, environmental friendly disposal techniques are required.

The effect of the adsorption of dyes on to the dolomite material of the present invention, as shown hereinbefore, showed an absorption capacity similar to that of activated carbons. As activated carbon is used as an absorbent for TBT, it is therefore expected that the activated dolomite material of the present invention would also be effective in TBT treatment of waste water.

Phosphate Adsorption/Flocculation

Ortho-phosphate accounts for 100% of fertiliser run-off and up to 90% of domestic sewerage. Experiments were conducted using a dolomite material prepared by charring at 800° C. for 8 hours of raw dolomite. The optimum pH range for the experiments was approximated to 10.0-10.1. The activated dolomite material was tested as a coagulant in a continuous stirred tank reactor system. It was shown that a dose of 0.03 g/L of the activated material provided a 95% removal of a phosphate concentration of 18500 ppm.

The present invention provides an adsorbent/flocculant which can be easily provided, and is therefore cheap in dealing with industrial waste water. Moreover, the ‘spent’ adsorbent/flocculant could possibly be subsequently used on land as a “liming” agent. If the dolomite material has a high content (e.g. 10%) of nitrate/phosphate, the spent adsorbent/flocculant would have significantly added value as a slow release fertiliser. Any adsorbed metallic ions on the dolomite material could also possibly provide a micro-nutrient fertiliser. Micro-nutrients are added at certain levels to soil to correct deficiencies.

1. A process for producing an adsorbent/flocculent material comprising the step of heating dolomite to around 800° C.

2. A process as claimed in claim 1 in which the dolomite is heated in any known heating or thermal process or calcination suitable to decompose the dolomite and change the surface porosity.

3. A process as claimed in claim 1 or claim 2 in which the dolomite is heated for between 4 and 24 hours.

4. A process as claimed in any one of the preceding claims in which the heated dolomite is washed with a material suitable for increasing the dolomite surface porosity.

5. A process as claimed in claim 4 in which the material is suitable for removing magnesium oxide from the surface pores.

6. A process as claimed in claim 4 or claim 5 in which the material is borax buffer.

7. An absorbent/flocculent material obtainable by the process of any of claims 1 to 6.

8. An absorbent/flocculent material obtainable by heating dolomite to around 800° C.

9. An absorbent/flocculent material as claimed in claim 7 or claim 8 having a specific surface area of at least 11 m².

10. Use of an absorbent/flocculent material according to one of claims 7 to 9 to absorb one or more substances from a material to be treated.

11. Use of a material as claimed in claim 10 in which the material to be treated is a liquid.

12. Use of a material as claimed in claim 11 in which the liquid is water.

13. Use of a material claimed in any one of claims 10 to 12 wherein the substance is a nitrate, phosphate, or tri-butyl tin.

14. An adsorbent/flocculent process for the treatment of a liquid material, generally water, wherein an adsorbent/flocculent material as defined in any one of claims 7 to 9 is located in the path of a flow of the liquid material, and one or more substances in the liquid material are adsorbed by the adsorbent/flocculent material.

15. A process as claimed in claim 14 in which the absorbent/flocculent material effects the removal of target ions from the liquid material.

16. A water treatment device having means for treating water, which means comprises an absorbent/flocculent material as defined in any one of claims 7 to 9.
